(19) United States
(12) Patent Application Publication
(10) Pub. No.: US 2015/0168737 A1
(43) Pub. Date: Jun. 18, 2015

(54) Laser Apparatus

(71) Applicants: Hisense Broadband Multimedia Technologies Co., Ltd., Qingdao (CN); HISENSE USA CORPORATION, Suwanee, GA (US); Hisense International Co., Ltd., Qingdao (CN)

(72) Inventors: Jian Yang, Qingdao (CN); Shanwen Li, Qingdao (CN); Tuo Chen, Qingdao (CN)

(21) Appl. No.: 14/559,174

(22) Filed: Dec. 3, 2014

Related U.S. Application Data
(63) Continuation of application No. PCT/CN2013/091153, filed on Dec. 31, 2013.

(30) Foreign Application Priority Data
Dec. 12, 2013 (CN) 201310682488.6

(51) Int. Cl. G02B 27/28; G02B 5/30; H01S 3/04; H01S 3/00; H01S 3/23

(52) U.S. Cl. CPC G02B 27/283; H01S 3/0071; H01S 3/23; H01S 3/0405; G02B 5/3083; G02B 27/30

(57) ABSTRACT

There is provided a laser apparatus. The laser apparatus includes first laser generator configured to generate first linearly polarized laser; a second laser generator configured to generate second linearly polarized laser; and a laser beam-combiner configured to combine the first linearly polarized laser and the second linearly polarized laser, of which polarization directions are perpendicular to each other, into a single beam of laser, wherein in the case that the polarization directions of the first linearly polarized laser and the second linearly polarized laser are not perpendicular to each other, the laser apparatus further includes a laser deflector arranged between the first laser generator and the laser beam-combiner; and the laser deflector is configured to rotate the polarization direction of the first linearly polarized laser so that the polarization directions of the first linearly polarized laser and the second linearly polarized laser are perpendicular to each other.

This application claims priority to and is a U.S. continuation application of International Application No. PCT/CN2013/091153, filed 31 Dec. 2013, which claims the priority to Chinese Patent Application No. 201310682488.6, filed with the Chinese Patent Office on Dec. 12, 2013 and entitled “Laser Apparatus”, the content of which is hereby incorporated by reference in its entirety.

### FIELD

The present disclosure relates to the field of optical communications and particularly to a laser apparatus.

### BACKGROUND

Wavelength Division Multiplexing (WDM) technology has been widely demanded in recent years along with an increasing bandwidth need for optical fiber communication.

Wavelength Division Multiplexing refers to concurrent coupling of optical signals with two or more wavelengths into a single optical fiber to thereby double a bandwidth of data transmission over the single optical fiber. As can be apparent, the wavelength division multiplexing, is distinctively characterized in that optical signals emitted by a plurality of signal sources need to be coupled concurrently into a single optical fiber.

### SUMMARY

At one aspect, One or more embodiments of the disclosure provide a laser apparatus, which includes: a first laser generator configured to generate first linearly polarized laser; a second laser generator configured to generate second linearly polarized laser; and a laser beam-combiner configured to combine the first linearly polarized laser and the second linearly polarized laser, of which polarization directions are perpendicular to each other, into a single beam of laser, wherein in the case that the polarization directions of the first linearly polarized laser and the second linearly polarized laser are not perpendicular to each other, the laser apparatus further includes a laser deflector arranged between the first laser generator and the laser beam-combiner; and the laser deflector is configured to rotate the polarization direction of the first linearly polarized laser so that the polarization directions of the first linearly polarized laser and the second linearly polarized laser are perpendicular to each other.

At another aspect, one or more embodiments of the disclosure provides a laser apparatus, which includes a first laser generator configured to generate first linearly polarized laser; a second laser generator configured to generate second linearly polarized laser; and a laser beam-combiner configured to combine the first linearly polarized laser and the second linearly polarized laser into a single beam of laser when polarization directions of the first linearly polarized laser and the second linearly polarized laser are perpendicular to each other.

### BRIEF DESCRIPTION OF THE DRAWINGS

In order to make the technical solution according to the embodiments of the disclosure more apparent, the drawings to be used in a description of the embodiments will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1(a) is a first schematic structural diagram of a laser apparatus according to one or more embodiments of the disclosure;

FIG. 1(b) is a second schematic structural diagram of a laser apparatus according to one or more embodiments of the disclosure;

FIG. 2 is a schematic diagram of selecting a single-axis crystal according to one or more embodiments of the disclosure;

FIG. 3(a) is a third schematic structural diagram of a laser apparatus according to one or more embodiments of the disclosure;

FIG. 3(b) is a fourth schematic structural diagram of a laser apparatus according to one or more embodiments of the disclosure;

FIG. 4(a) is a first schematic structural diagram of a package of a laser apparatus according to one or more embodiments of the disclosure;

FIG. 4(b) is a second schematic structural diagram of a package of a laser apparatus according to one or more embodiments of the disclosure; and

FIG. 5 is a schematic diagram of bonding a laser chip according to one or more embodiments of the disclosure.

### LIST OF REFERENCE NUMERALS

10—laser apparatus; 101—first laser generator; 102—second laser generator; 103—laser beam-combiner; 104—laser deflector; 105—collimating lens; 106—condensing lens; 20—chip base; 30—L-shaped thermally dissipating base; 301—first bottom surface of L-shaped thermally dissipating base; 302—second bottom surface of L-shaped thermally dissipating base; 40—thermal resistor; 50—temperature control module; 60—backlight detector; 701—package base; 702—light-transmitting package cap.

### DETAILED DESCRIPTION OF THE EMBODIMENTS

The technical solution according to the embodiments of the disclosure will be described below with reference to the drawings. Apparently the described embodiments are only a part but not all of the embodiments of the disclosure. Based upon the embodiments of the disclosure, all of other embodiments derived by those ordinarily skilled in the art without any inventive effort shall come into the scope of the disclosure.

At one aspect, one or more embodiments of the disclosure provide a laser apparatus to improve the efficiency of coupling while lowering the complexity of a process.

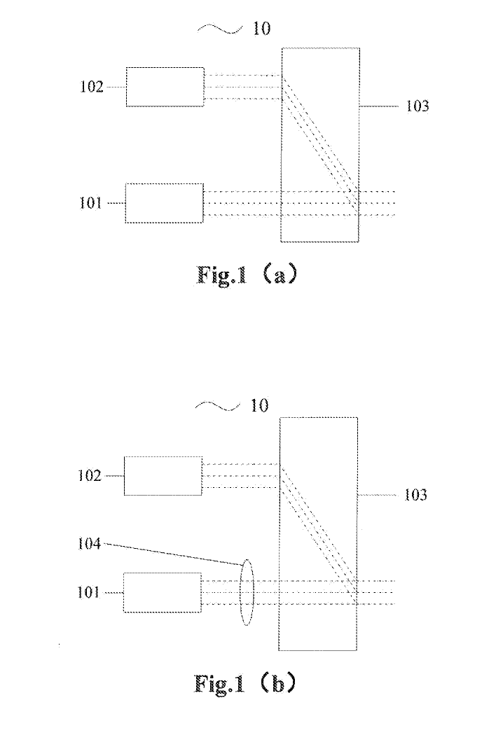

An embodiment of the disclosure provides a laser apparatus 10, and as illustrated in FIG. 1(a) and FIG. 1(b), the laser apparatus 10 may include a first laser generator 101 configured to generate first linearly polarized laser; a second laser generator 102 configured to generate second linearly polarized laser; and a laser beam-combiner 103 configured to combine the first linearly polarized laser and the second linearly polarized laser, of which polarization directions are perpendicular to each other, into a single beam of the laser. In the case that the polarization directions of the first linearly polarized laser and the second linearly polarized laser are not perpendicular to each other, the laser apparatus 10 may further include a laser deflector 104 arranged between the first laser generator 101 and the laser beam-combiner 103; and the laser deflector 104 may be configured to rotate the polarization direction of the first linearly polarized laser so that the polarization directions of the first linearly polarized laser and the second linearly polarized laser are perpendicular to each other.

In the case that the polarization directions of the first linearly polarized laser generated by the first laser generator 101 and the second linearly polarized laser generated by the second linearly polarized laser 102 are perpendicular to each other, when the first linearly polarized laser and the second linearly polarized laser enter the laser beam-combiner 103, the laser beam-combiner 103 may combine the two beams of laser, of which the polarization directions are perpendicular to each other, into the same beam of laser to be coupled into a single optical fiber.

In the case that the polarization direction of the first linearly polarized laser generated by the first laser generator 101 and the polarization direction of the second linearly polarized laser generated by the second linearly polarized laser 102 are not perpendicular to each other, before the first linearly polarized laser and the second linearly polarized laser enter the laser beam-combiner 103, it may be necessary to rotate the polarization direction of one of the beams of laser, for example, the first linearly polarized laser, to enable the polarization directions of the first linearly polarized laser and the second linearly polarized laser being perpendicular to each other, and thus when the first linearly polarized laser and the second linearly polarized laser enter the laser beam-combiner 103, the laser beam-combiner 103 may combine the two beams of laser of which the polarization directions are perpendicular to each other into the same beam of laser to be coupled into a single optical fiber.

It shall be noted that firstly the laser apparatus 10 is configured to couple the two beams of laser into a single beam, so the first linearly polarized laser generated by the first laser generator 101 and the second linearly polarized laser generated by the second laser generator 102 should propagate in parallel and consistent directions. Moreover the first linearly polarized laser and the second linearly polarized laser may be at the same wavelength or may be at different wavelengths, but the disclosure may not be limited in this regard.

Secondly both the first laser generator 101 and the second laser generator 102 may select to use single-channel laser chips or tunable multi-channel laser chips.

Particularly the laser generators are preferably linearly polarized laser chips in the Transverse Electric (TE) mode, where the polarization direction of linearly polarized light generated by each of the linearly polarized laser chips in the TE mode is in the same plane as an active area of the linearly polarized laser chip in the TE mode.

With the same laser generators selected for use, the first laser generator 101 and the second laser generator 102 emit totally the same laser; and the difference in polarization direction between the first linearly polarized laser and the second linearly polarized laser arises from the difference in spatial geometrical relationship between the first laser generator 101 and the second laser generator 102 and depends upon the relative location of the first laser generator 101 and the second laser generator 102.

If the first laser generator 101 and the second laser generator 102 are arranged parallel to each other, then the polarization directions of the first linearly polarized laser and the second linearly polarized laser generated by them are parallel; and if the first laser generator 101 and the second laser generator 102 are arranged perpendicular to each other, then the polarization directions of the first linearly polarized laser and the second linearly polarized laser generated by them are perpendicular to each other; and of course, the first laser generator 101 and the second laser generator 102 may alternatively be arranged inclined from each other, and at this time the polarization directions of the first linearly polarized laser and the second linearly polarized laser are intersecting but not perpendicular.

Thirdly the laser deflector 104 is configured to rotate the polarization direction of the first linearly polarized laser so that the polarization directions of the first linearly polarized laser and the second linearly polarized laser are perpendicular to each other, and thus the laser deflector 104 needs to be arranged between the first laser generator 101 and the laser beam-combiner 103 on an optical path of the first linearly polarized laser.

Moreover also the spatial relative location relationship between the first laser generator 101 and the second laser generator 102 may be adjusted so that the polarization directions of the first linearly polarized laser and the second linearly polarized laser are perpendicular to each other. For example, the first laser generator 101 and the second laser generator 102 may be arranged perpendicular to each other as long as their active areas are at the same height. The active area of the first laser generator 101 or the second laser generator 102 is located on the top surface of the laser generator, that is, the first laser generator 101 and the second laser generator 102 are arranged respectively on two perpendicular sides of a chip base (e.g., L-shaped structure), and where the height of the active area refers to the same distance from active area of the first laser generator 101 or the second laser generator 102 to the level surface of the chip base.

Fourthly the laser beam-combiner 103 is configured to combine the two beams of laser, of which the polarization directions are perpendicular to each other, into a single beam, so the laser beam-combiner 103 needs to be located on the optical paths of the two beams of laser, and moreover the two parallel beams of laser above, as the incident light of the laser beam-combiner 103, need to be in the primary section of the laser beam-combiner 103.

Particularly the laser beam-combiner 103 may be a birefringent crystal beam-combiner.

Here birefringence phenomenon of the birefringent crystal is briefed as follows: a beam of parallel natural light is normal incident on a surface of the birefringent crystal so that the beam is split into two beams, where one of the beams in the polarization electric vector direction perpendicular to the primary section (the o beam) will not be refracted and the other beam in the polarization electric vector direction parallel to the primary section (the e beam) will be refracted; and as may be apparent, both of the beams as a result of splitting are linearly polarized beams.

In the embodiment of the disclosure, a single-axis crystal is preferably used as the laser beam-combiner 103 so that the two beams of linearly polarized laser may be combined into a single beam because the single-axis crystal may not refract the linearly polarized o beam but may refract the linearly polarized e beam.

Particularly the spatial relative location relationship between the first laser generator 101 and the second laser generator 102 may be adjusted or the laser deflector 104 may be arranged, so that the polarization directions of the first linearly polarized laser and the second linearly polarized laser are perpendicular to each other, and for the single-axis crystal, one of the beams is a linearly polarized o beam, and the other beam is a linearly polarized e beam. The linearly polarized e beam is refracted by the single-axis crystal so that the linearly polarized o beam and the linearly polarized e beam coincide spatially at the light output end of the single-axis crystal into the same beam of laser, and thus the two beams of laser generated by the laser generators are coupled concurrently into a single optical fiber.

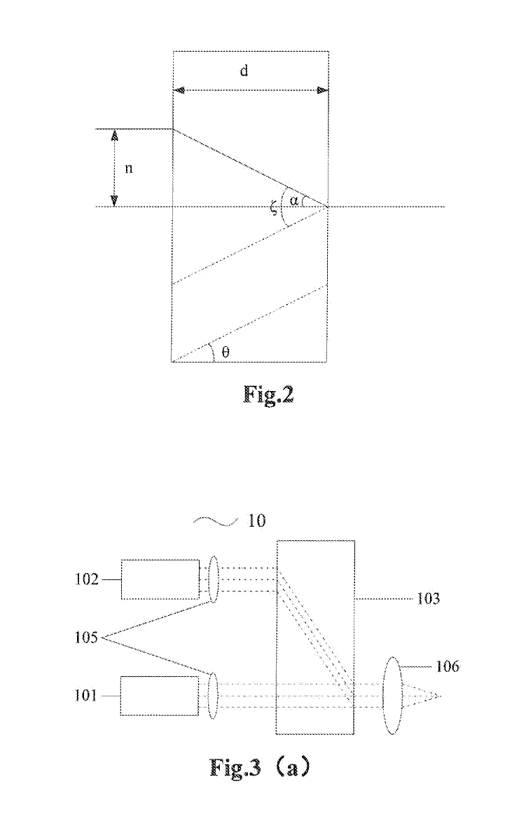

Hereupon, as illustrated in FIG. 2, the single-axis crystal is selected under the following principle: the sharp angle θ between the optical axis of the single-axis crystal and an incident ray may be defined by obtaining the maximal deviation angle α of an e beam, where the refracted beam is an e beam, the refractivity of the e beam of the single-axis crystal is nₑ, the non-refracted beam is an o beam, the refractivity of the o beam of the single-axis crystal is nₒ, and the values of both the refractivities are inherent parameters of the single-axis crystal.

Under this principle, the sharp angle θ between the optical axis of the single-axis crystal and an incident ray is defined as follows: if the deviation angle of the e beam relative to the optical axis of the single-axis crystal is ξ, then:

$$cot ξ = \frac{{n}_{e}^{2}}{{n}_{o}^{2}} cot θ ;$$

Thus α may be derived as follows:

$$α = \vert ξ - θ \vert = \vert {cot}^{- 1} ( \frac{{n}_{e}^{2}}{{n}_{o}^{2}} cot θ ) - θ \vert .$$

The equation above derived at the first order is equal to 0, i.e., the maximum of α.

Hereupon when the thickness of the single-axis crystal is d, the distance n between the first laser generator 101 and the second laser generator 102 may also be derived by a triangular function.

Hereupon with an appropriate single-axis crystal selected, the distance between the first laser generator 101 and the second laser generator 102 may be determined as a function of the inherent parameters and the thickness of the single-axis crystal, to thereby set reasonably the location relationships between the respective apparatuses in the laser apparatus 10 so as to combine the two beams of laser into a single beam.

An embodiment of the disclosure provides a laser apparatus 10 including a first laser generator 101 configured to generate first linearly polarized laser; a second laser generator 102 configured to generate second linearly polarized laser; and a laser beam-combiner 103 configured to combine the first linearly polarized laser and the second linearly polarized laser of which polarization directions are perpendicular to each other into a single beam. In the case that the polarization directions of the first linearly polarized laser and the second linearly polarized laser are not perpendicular to each other, the laser apparatus 10 further includes a laser deflector 104 arranged between the first laser generator 101 and the laser beam-combiner 103; and the laser deflector 104 is configured to rotate the polarization direction of the first linearly polarized laser so that the polarization directions of the first linearly polarized laser and the second linearly polarized laser are perpendicular to each other.

As may be apparent from the description above, the relative location relationship between the first laser generator 101 and the second laser generator 102 may be adjusted or the laser deflector 104 may be arranged between the first laser generator 101 and the second laser generator 102, so that the polarization direction of the first linearly polarized laser generated by the first laser generator 101 and the polarization direction of the second linearly polarized laser generated by the second laser generator 102 are perpendicular to each other, and thus when the first linearly polarized laser and the second linearly polarized laser enter the laser beam-combiner 103, the laser beam-combiner 103 may combine directly the two beams of laser of which the polarization directions are perpendicular to each other into the same beam of laser to be coupled into a single optical fiber. There may be a low loss of optical power and high efficiency of coupling in the course of coupling; and moreover the structure the laser apparatus 10 according to the embodiment of the disclosure may be simple to thereby lower the complexity of the process.

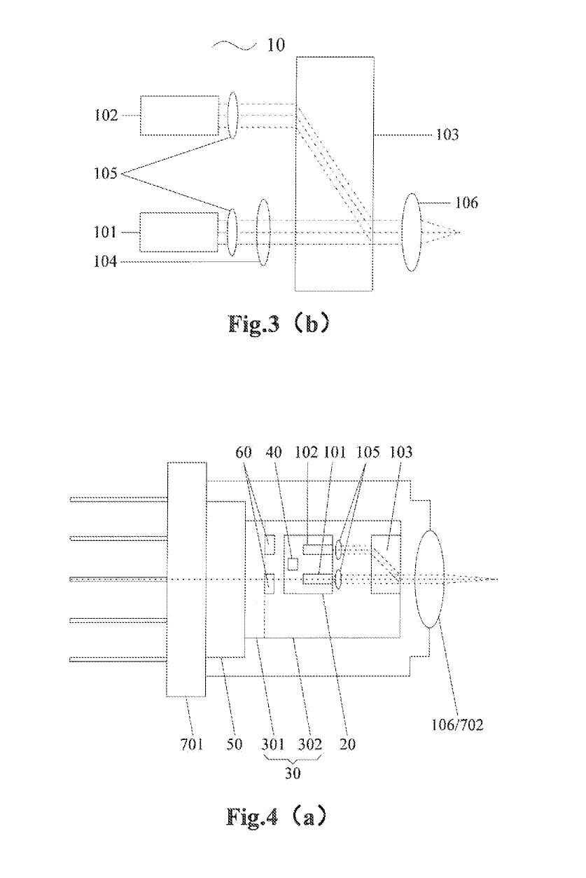

Optionally as illustrated in FIG. 3(a) and FIG. 3(b), the laser apparatus 10 may further include at least two collimating lenses 105 configured to collimate the first linearly polarized laser and the second linearly polarized laser respectively; and the at least two collimating lenses 105 are arranged respectively between the first laser generator 101 and the laser beam-combiner 103 and between the second laser generator 102 and the laser beam-combiner 103.

Particularly the optical axis of the collimating lens 105 between the first laser generator 101 and the laser beam-combiner 103 coincides with the axis of the beam center of the first linearly polarized laser, that is, the collimating lens 105 between the first laser generator 101 and the laser beam-combiner 103 is on the same optical axis as the first linearly polarized laser; and the optical axis of the collimating lens 105 between the second laser generator 102 and the laser beam-combiner 103 coincides with the axis of the beam center of the second linearly polarized laser, that is, the collimating lens 105 between the second laser generator 102 and the laser beam-combiner 103 is on the same optical axis as the second linearly polarized laser.

Here the number of collimating lenses 105 may be particularly set without any limitation thereto, but may be decided by a real effect of collimating the laser, as long as at least one of the collimating lenses 105 may be ensured to be arranged between each of the laser generators and the laser beam-combiner 103.

Since the collimating lenses 105 are configured to focus and collimate the laser generated by the first laser generator 101 and the second laser generator 102, the distances between the collimating lenses 105 and the laser generators need to be maintained in some range to facilitate focusing and collimating of the laser generated by the laser generators. Hereupon in the case that the laser deflector 104 is arranged between the first laser generator 101 and the laser beam-combiner 103, one of the collimating lenses 105 is preferably arranged between the first laser generator 101 and the laser deflector 104.

In order to achieve the best effect of collimating, the collimating lenses 105 preferably adopt an array of micro-lenses, and the distances between the array of micro-lenses and the light output ends of the laser generators are arranged between 2 mm and 5 mm. The optical apertures of the lenses in the array of micro-lenses may be adjusted as a function of the divergence angles of the laser generators and the designed distances between the lenses and the laser generators, and the distance between the centers of the lenses may be determined precisely as a function of the refractivity of an e beam by the laser beam-combiner 103, e.g. a single-axis crystal, and the thickness of the single-axis crystal.

Moreover in order to further concentrate the beam of laser as a result of beam-combining, optionally referring to FIG. 3(a) and FIG. 3(b), the laser apparatus 10 may further include a condensing lens 106 arranged at the light output ends of the laser beam-combiner 103; and the condensing lens 106 is configured to focus the combined beam of laser, where the condensing lens 106 is arranged in the propagation direction of the combined beam of laser and on the same optical axis as the combined beam of laser.

Thus the first linearly polarized laser and the second linearly polarized laser of which the polarization directions are perpendicular to each other are combined by the laser beam-combiner 103 into the same beam of laser which in turn enters the condensing lens 106 for focusing into a beam of laser being more concentrated for a positive effect on the efficiency of coupling over the optical fiber.

As may be apparent from the description above, the laser apparatus 10 may include the first laser generator 101, the second laser generator 102 and the laser beam-combiner 103 and further the collimating lenses 105 respectively between the first laser generator 101 and the laser beam-combiner 103 and between the second laser generator 102 and the laser beam-combiner 103 and the condensing lens 106 at the light output end of the laser beam-combiner 103, where in the case that the polarization directions of the first linearly polarized laser and the second linearly polarized laser are not perpendicular to each other, the laser apparatus 10 further includes the laser deflector 104 between the collimating lens 105 corresponding to the first laser generator 101 and the laser beam-combiner 103.

Here in order to make the laser apparatus 10 more compact in structure, the collimating lenses 105, the laser deflector 104 and the laser beam-combiner 103 may be integrated together as an integral optical element.

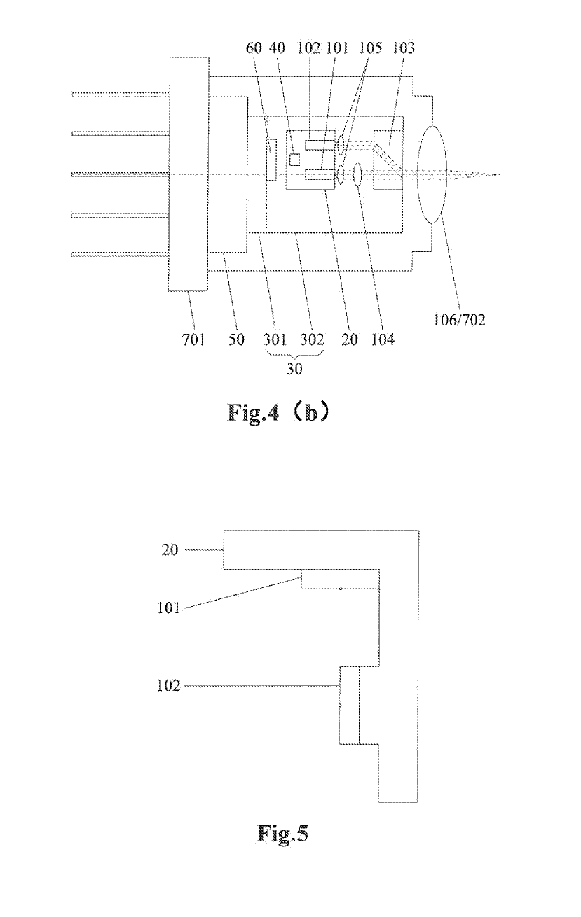

Hereupon optionally as illustrated in FIG. 4(a) and FIG. 4(b), the first laser generator 101 and the second laser generator 102 may be arranged parallel on the same plane of a chip base 20, and both the light output ends of the first laser generator 101 and the second laser generator 102 are arranged on the sides thereof proximate to the laser beam-combiner 103.

Particularly active areas of the first laser generator 101 and the second laser generator 102 are parallel and are at the same height, so that the first linearly polarized laser and the second linearly polarized laser may propagate in parallel and consistent directions. In a particular structure, both the structures of the active areas of the first laser generator 101 and the second laser generator 102 are strips, where the active areas being parallel refers to the two strip structures being parallel, and the active areas being at the same height refers to the active areas being at the same distance from the chip base.

It shall be noted that in this embodiment, the chip base 20 is preferably a planar chip base; and in the case that the laser generators are laser chips, the surface of the planar chip base are provided with bonding locations where the laser chips and other apparatuses are bonded to the surface of the planar chip base.

Further optionally the laser deflector 104 may be a 90-degree optically rotating sheet arranged between the first laser generator 101 and the laser beam-combiner 103.

When the first laser generator 101 and the second laser generator 102 are arranged parallel on the same plane of the chip base 20, and the active areas of the first laser generator 101 and the second laser generator 102 are parallel and at the same height, the first linearly polarized laser and the second linearly polarized laser propagate in the same direction and polarization directions thereof are parallel. In this case, the 90-degree optically rotating sheet may be arranged between the first laser generator 101 and the laser beam-combiner 103 to rotate the polarization direction of the first linearly polarized laser by 90 degrees, so that the polarization directions of the first linearly polarized laser and the second linearly polarized laser are perpendicular to each other. Thus when the first linearly polarized laser and the second linearly polarized laser enter the laser beam-combiner 103, the laser beam-combiner 103 may combine the two beams of laser of which the polarization directions are perpendicular to each other into the same beam of laser to be coupled into a single optical fiber.

Furthermore the laser apparatus 10 further includes an L-shaped thermally dissipating base 30, where the chip base 20, the laser deflector 104 (the 90-degree optically rotating sheet) and the laser beam-combiner 103 are arranged on a first bottom surface 301 of the L-shaped thermally dissipating base. In the case that the laser apparatus 10 includes the collimating lenses 105, the collimating lenses 105 are also arranged on the first bottom surface 301 of the L-shaped thermally dissipating base.

Hereupon positioning grooves or positioning marks of the collimating lenses 105, the laser deflector 104 (the 90-degree optically rotating sheet) and the laser beam-combiner 103 are further arranged on the first bottom surface 301 of the L-shaped thermally dissipating base.

Here the L-shaped thermally dissipating base 30 is preferably made of a tungsten-copper alloy material, and the L-shaped thermally dissipating base 30 may be an L-shaped thermally dissipating cooper block. Of course the material of the L-shaped thermally dissipating base 30 may not be limited thereto as long as it has a good effect of thermal dissipation and may act as a support.

Alternatively referring to FIG. 4(a) and FIG. 4(b), the first laser generator 101 and the second laser generator 102 may alternatively be arranged to be perpendicular to each other and respectively on two perpendicular planes of the chip base 20, and both the light output ends of the first laser generator 101 and the second laser generator 102 may be arranged on the sides thereof proximate to the laser beam-combiner 103.

Particularly the active areas of the first laser generator 101 and the second laser generator 102 are parallel and at the same height, so that the first linearly polarized laser and the second linearly polarized laser propagate in parallel and consistent directions.

It shall be noted that in this embodiment, the chip base 20 is preferably an L-shaped chip base; and as illustrated in FIG. 5, in the case that the laser generators are laser chips, both of the laser chips may be soldered or bonded on two perpendicular planes of the L-shaped chip base.

Moreover when the first laser generator 101 and the second laser generator 102 are arranged on two perpendicular planes of the L-shaped chip base, the active areas of the first laser generator 101 and the second laser generator 102 need to be at the same height; and hereupon a protruding platform may be arranged on one of the planes of the L-shaped chip base to enable the active area of the first laser generator 101 to be at the same height as the active area of the second laser generator 102; and the thickness of the protruding platform may be designed as a function of the real sizes of the laser generators 102.

Furthermore the laser apparatus 10 may further includes the L-shaped thermally dissipating base 30, where both the chip base 20 and, the laser beam-combiner 103 are arranged on the first bottom surface 301 of the L-shaped thermally dissipating base. In the case that the laser apparatus 10 includes the collimating lenses 105, the collimating lenses 105 may also be arranged on the first bottom surface 301 of the L-shaped thermally dissipating base.

Hereupon positioning grooves or positioning marks of the collimating lenses 105 and the laser beam-combiner 103 are further arranged on the first bottom surface 301 of the L-shaped thermally dissipating base.

Based upon the description above, further optionally, referring to FIG. 4(a) and FIG. 4(b), the laser apparatus 10 further includes a thermal resistor 40 arranged on the chip base 20, where the thermal resistor 40 is arranged on the sides of the first laser generator 101 and the second laser generator 102 away from the light output ends, and the thermal resistor 40 is at the same vertical distance from the first laser generator 101 and the second laser generator 102 and configured to sense temperature of the first laser generator 101 and temperature of the second laser generator 102.

Particularly the thermal resistor 40 may be a semiconductor thermal resistor.

Since the temperature is increased during that the first laser generator 101 and the second laser generator 102 emit the laser, and the variation in temperature may have some influence on the wavelengths of the laser, thus in order ensure stable wavelengths of the laser, preferably the laser apparatus 10 further includes a temperature control module 50 arranged on the outer side of a second bottom surface 302 of the L-shaped thermally dissipating base and in contact with the second bottom surface 302 of the L-shaped thermally dissipating base; and the temperature control module 50 is configured to control the temperature of the first laser generator 101 and the temperature of the second laser generator 102 as a function of the temperature sensed by the thermal resistor 40 to be maintained in a stable range.

Particularly the temperature control module 50 may be a Thermoelectric Cooler (TEC) device.

Here since the temperature control module 50 is arranged on the outer side of the second bottom surface 302 of the L-shaped thermally dissipating base and directly contacts with the second bottom surface 302 of the L-shaped thermally dissipating base, and the L-shaped thermally dissipating base 30 is an L-shaped thermally dissipating copper block, thus the temperature control module 50 may control the temperature of the first laser generator 101 and the temperature of the second laser generator 102 through the L-shaped thermally dissipating copper block.

By way of an example, when the temperature of the first laser generator 101 and the second laser generator 102 rises beyond some specific range, the temperature control module 50, e.g., a TEC apparatus, starts to cool them and conducts heat away from the first laser generator 101 and the second laser generator 102 through the L-shaped thermally dissipating copper block in direct contact therewith, which is as a thermally conductive medium, to thereby lower the temperature thereof.

Optionally the laser apparatus 10 may further include a backlight detector 60 arranged on the inner side of the second bottom surface 302 of the L-shaped thermally dissipating base.

Particularly in the case that the first laser generator 101 and the second laser generator 102 do not operate concurrently, the laser apparatus 10 may be arranged with only one backlight detector 60. In this case, the backlight detector 60 may be arranged between the two laser generators, and the center of an operating area of the backlight detector 60 is at the same vertical distance from the two laser generators.

In the case that the first laser generator 101 and the second laser generator 102 operate concurrently, the laser apparatus 10 needs to be arranged with two backlight detectors 60. In this case, the two backlight detectors 60 may be arranged to be positioned in correspondence to the first laser generator 101 and the second laser generator 102 respectively.

Furthermore the laser apparatus 10 may further include a package base 701 and a light-transmitting package cap 702, where the L-shaped thermally dissipating base 30 is arranged on the package base 701, and the light-transmitting package cap 702 is arranged in the propagation direction of the combined beam of laser.

In the case that the laser apparatus 10 includes the condensing lens 106, the light-transmitting package cap 702 may be integrated to the condensing lens 106.

Here preferably the laser apparatus 10 is packaged by a To package or of course it may alternatively be packaged by an XMD package, a butterfly package, etc.

The embodiments of the present disclosure provides another laser apparatus, which includes: a first laser generator configured to generate first linearly polarized laser; a second laser generator configured to generate second linearly polarized laser; and a laser beam-combiner configured to combine the first linearly polarized laser and the second linearly polarized laser into a single beam of laser when the polarization directions of the first linearly polarized laser and the second linearly polarized laser are perpendicular to each other.

Optionally, the laser apparatus further includes a laser deflector arranged between the first laser generator and the laser beam-combiner; and the laser deflector is configured, when the polarization directions of the first linearly polarized laser and the second linearly polarized laser are not perpendicular to each other, to rotate polarization direction of the first linearly polarized laser so that the polarization directions of the first linearly polarized laser and the second linearly polarized laser are perpendicular to each other.

Optionally the laser apparatus further includes at least two collimating lenses configured to collimate the first linearly polarized laser and the second linearly polarized laser respectively; and the at least two collimating lenses are arranged respectively between the first laser generator and the laser beam-combiner and between the second laser generator and the laser beam-combiner.

Optionally the laser apparatus further includes a condensing lens arranged at a light output end of the laser beam-combiner and configured to focus the combined beam of laser.

Optionally the first laser generator and the second laser generator are arranged parallel on a same plane of a chip base, and both light output ends of the first laser generator and the second laser generator are arranged on the sides thereof proximate to the laser beam-combiner; and wherein active areas of the first laser generator and the second laser generator are parallel and at a same height.

Optionally the laser deflector is a 90-degree optically rotating sheet.

Optionally the laser apparatus further includes an L-shaped thermally dissipating base; and the chip base, the laser deflector and the laser beam-combiner are arranged on a first bottom surface of the L-shaped thermally dissipating base; and the laser apparatus further includes a thermal resistor arranged on the chip base; and the thermal resistor is arranged on the sides of the first laser generator and the second laser generator away from the light output ends, and the thermal resistor is at a same vertical distance from the first laser generator and the second laser generator and configured to sense temperature of the first laser generator and the second laser generator.

The laser apparatus 10 will be described below in details in a particular embodiment.

Referring to FIG. 3(b), the first laser generator 101 and the second laser generator 102 are arranged parallel, where the first laser generator 101 is an o-beam light source, and the second laser generator 102 is an e-beam light source.

The first linearly polarized laser generated by the first laser generator 101 and the second linearly polarized laser generated by the second laser generator 102 are formed into two parallel beams of light by their corresponding collimating lenses 105.

The polarization direction of the first linearly polarized laser generated by the first laser generator 101 is verticalized by the 90-degree optically rotating sheet, so that the first linearly polarized laser is a linearly polarized o beam relative to the single-axis crystal, and the second linearly polarized laser generated by the second laser generator 102 is a linearly polarized e beam relative to the single-axis crystal.

The linearly polarized o beam is not refracted by the single-axis crystal, but still propagates straightly and exits the light output end of the single-axis crystal; and the linearly polarized e beam is refracted by the single-axis crystal and propagates in a changed direction, and the refracted linearly-polarized e beam is combined with the linearly polarized o beam into a single beam by reasonably setting the thickness of the single-axis crystal and the distance between the two laser generators, and exits the light output ends of the single-axis crystal together with the linearly polarized o beam, and thus the two beams of laser are combined into a single beam.

The combined beam of laser exiting the single-axis crystal is focused by the condensing lens 106 and coupled into a single optical fiber.

An embodiment of the disclosure provides a laser apparatus including: a first laser generator configured to generate first linearly polarized laser; a second laser generator configured to generate second linearly polarized laser; and a laser beam-combiner configured to combine the first linearly polarized laser and the second linearly polarized laser of which the polarization directions are perpendicular to each other into a single beam of laser, wherein in the case that the polarization directions of the first linearly polarized laser and the second linearly polarized laser are not perpendicular to each other, the laser apparatus further includes a laser deflector arranged between the first laser generator and the laser beam-combiner; and the laser deflector is configured to rotate the polarization direction of the first linearly polarized laser so that the polarization directions of the first linearly polarized laser and the second linearly polarized laser are perpendicular to each other.

Hereupon the relative location relationship between the first laser generator and the second laser generator may be adjusted or the laser deflector may be arranged between the first laser generator and the second laser generator so that the polarization direction of the first linearly polarized laser generated by the first laser generator and the polarization direction of the second linearly polarized laser generated by the second laser generator are perpendicular to each other, and thus when the first linearly polarized laser and the second linearly polarized laser enter the laser beam-combiner, the laser beam-combiner may directly combine the two beams of laser of which the polarization directions are perpendicular to each other into the same beam of laser to be coupled into a single optical fiber. There may be a low loss of optical power and high efficiency of coupling in the course of coupling; and moreover the structure of the laser apparatus according to the embodiment of the disclosure may be simple to thereby lower the complexity of the process.

Evidently those skilled in the art may make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A laser apparatus, comprising:
a first laser generator configured to generate first linearly polarized laser;
a second laser generator configured to generate second linearly polarized laser; and
a laser beam-combiner configured to combine the first linearly polarized laser and the second linearly polarized laser, of which polarization directions are perpendicular to each other, into a single beam of laser,
wherein in the case that the polarization directions of the first linearly polarized laser and the second linearly polarized laser are not perpendicular to each other, the laser apparatus further comprises a laser deflector arranged between the first laser generator and the laser beam-combiner; and
the laser deflector is configured to rotate the polarization direction of the first linearly polarized laser so that the polarization directions of the first linearly polarized laser and the second linearly polarized laser are perpendicular to each other.

2. The laser apparatus according to claim 1, wherein the laser apparatus further comprises at least two collimating lenses configured to collimate the first linearly polarized laser and the second linearly polarized laser respectively; and
the at least two collimating lenses are arranged respectively between the first laser generator and the laser beam-combiner and between the second laser generator and the laser beam-combiner.

3. The laser apparatus according to claim 1, wherein the laser apparatus further comprises a condensing lens arranged at a light output end of the laser beam-combiner and configured to focus the combined beam of laser.

4. The laser apparatus according to claim 1, wherein the first laser generator and the second laser generator are arranged parallel on a same plane of a chip base, and both light output ends of the first laser generator and the second laser generator are arranged on the sides thereof proximate to the laser beam-combiner; and
wherein active areas of the first laser generator and the second laser generator are parallel and at a same height.

5. The laser apparatus according to claim 4, wherein the laser deflector is a 90-degree optically rotating sheet.

6. The laser apparatus according to claim 5, wherein the laser apparatus further comprises an L-shaped thermally dissipating base; and
the chip base, the laser deflector and the laser beam-combiner are arranged on a first bottom surface of the L-shaped thermally dissipating base; and
the laser apparatus further comprises a thermal resistor arranged on the chip base; and
the thermal resistor is arranged on the sides of the first laser generator and the second laser generator away from the light output ends, and the thermal resistor is at a same vertical distance from the first laser generator and the second laser generator and configured to sense temperature of the first laser generator and the second laser generator.

7. The laser apparatus according to claim 1, wherein the first laser generator and the second laser generator are arranged to be perpendicular to each other and respectively on two perpendicular sides of a chip base, and both light output ends of the first laser generator and the second laser are arranged on the sides thereof proximate to the laser beam-combiner; and
wherein active areas of the first laser generator and the second laser generator are parallel and at a same height.

8. The laser apparatus according to claim 7, wherein, the laser apparatus further comprises an L-shaped thermally dissipating base; and
the chip base and the laser beam-combiner are arranged on a first bottom surface of the L-shaped thermally dissipating base; and
the laser apparatus further comprises a thermal resistor arranged on the chip base; and
the thermal resistor is arranged on the sides of the first laser generator and the second laser generator away from the light output ends, and the thermal resistor is at a same vertical distance from the first laser generator and the second laser generator and configured to sense temperature of the first laser generator and the second laser generator.

9. The laser apparatus according to claim 6, wherein the laser apparatus further comprises a temperature control module, which is arranged on the outer side of a second bottom surface of the L-shaped thermally dissipating base and contacts with the second bottom surface of the L-shaped thermally dissipating base; and
the temperature control module is configured to control the temperature of the first laser generator and the second laser generator as a function of the temperature sensed by the thermal resistor.

10. The laser apparatus according to claim 6, wherein the laser apparatus further comprises a backlight detector arranged on the inner side of a second bottom surface of the L-shaped thermally dissipating base.

11. The laser apparatus according to claim 6, wherein the laser apparatus further comprises a package base and a light-transmitting package cap; and
wherein the L-shaped thermally dissipating base is arranged on the package base, and the light-transmitting package cap is arranged in the propagation direction of the combined beam of laser.

12. The laser apparatus according to claim 1, wherein the first laser generator is a single-channel laser chip or a tunable multi-channel laser chip; and
the second laser generator is a single-channel laser chip or a tunable multi-channel laser chip.

13. The laser apparatus according to claim 1, wherein the laser beam-combiner is a birefringent crystal beam-combiner.

14. A laser apparatus, comprising:
a first laser generator configured to generate first linearly polarized laser;
a second laser generator configured to generate second linearly polarized laser; and
a laser beam-combiner configured to combine the first linearly polarized laser and the second linearly polarized laser into a single beam of laser when polarization directions of the first linearly polarized laser and the second linearly polarized laser are perpendicular to each other.

15. The laser apparatus according to claim 14, wherein the laser apparatus further comprises a laser deflector arranged between the first laser generator and the laser beam-combiner; and
the laser deflector is configured, when the polarization directions of the first linearly polarized laser and the second linearly polarized laser are not perpendicular to each other, to rotate the polarization direction of the first linearly polarized laser so that the polarization directions of the first linearly polarized laser and the second linearly polarized laser are perpendicular to each other.

16. The laser apparatus according to claim 14, wherein the laser apparatus further comprises at least two collimating lenses configured to collimate the first linearly polarized laser and the second linearly polarized laser respectively; and
the at least two collimating lenses are arranged respectively between the first laser generator and the laser beam-combiner and between the second laser generator and the laser beam-combiner.

17. The laser apparatus according to claim 14, wherein the laser apparatus further comprises a condensing lens arranged at a light output end of the laser beam-combiner and configured to focus the combined beam of laser.

18. The laser apparatus according to claim 14, wherein the first laser generator and the second laser generator are arranged parallel on a same plane of a chip base, and both light output ends of the first laser generator and the second laser generator are arranged on the sides thereof proximate to the laser beam-combiner; and
wherein active areas of the first laser generator and the second laser generator are parallel and at a same height.

19. The laser apparatus according to claim 15, wherein the laser deflector is a 90-degree optically rotating sheet.

20. The laser apparatus according to claim 15, wherein the laser apparatus further comprises an L-shaped thermally dissipating base; and
the chip base, the laser deflector and the laser beam-combiner are arranged on a first bottom surface of the L-shaped thermally dissipating base; and
the laser apparatus further comprises a thermal resistor arranged on the chip base; and
the thermal resistor is arranged on the sides of the first laser generator and the second laser generator away from the light output ends, and the thermal resistor is at a same vertical distance from the first laser generator and the second laser generator and configured to sense temperature of the first laser generator and the second laser generator.
